(19) United States
(12) Patent Application Publication
(10) Pub. No.: US 2015/0335088 A1
(43) Pub. Date: Nov. 26, 2015

(54) SWEAT BAND SUN PROTECTOR

(71) Applicant: JOAN MAGGIO, Cheswick, PA (US)

(72) Inventor: JOAN MAGGIO, Cheswick, PA (US)

(21) Appl. No.: 14/282,578

(22) Filed: May 20, 2014

(51) Int. Cl. A42B 1/24; G02C 3/02

(52) U.S. Cl. CPC A42B 1/247; G02C 3/02

(57) ABSTRACT

Lenses (14 and 16) are secured to a head band (12) and covered by a sheet (39). One part (18a and 19a) of a fastener is attached to sheet (39) and the complementary part (18b and 19b) of the fastener is attached to lenses (14 and 16) to connect the lenses to the band. In one embodiment, the band (12) and sheet (39) form a pocket (48) that may receive a lens subassembly (44) such that portions of lenses (14 and 16) extend from pocket (48).

### BACKGROUND OF THE INVENTION

1. Field of the Invention

The presently disclosed invention is related to sun glasses in combination with sweat bands. This combination is intended for use in circumstances where conventional eyeglass frames do not maintain a stable position on the wearer's face and, more particularly, circumstances under which the user's activity causes sweating or jostling that causes conventional eyeglass frames to slip out of position.

2. Description of the Prior Art

People have used glasses with tinted lenses for many years to ease eyestrain and to protect them from exposure to ultraviolet radiation which has been found to be harmful over periods of long exposure. Often, such eyewear is used in circumstances where the user is in extreme temperatures causing them to sweat profusely, such as in gardening or lawn care; or where the user experiences high degrees of acceleration, such as in outdoor sports and recreational activity. In such circumstances it has been found that sun glasses with conventional frames fail to maintain the sun glasses in a proper position. Often, the frames slip out of position on the user's face; compromising the user's vision and causing irritation and frustration on the part of the wearer.

Various devices have been proposed to correct this problem. For example, one solution has been to attach a strap between the bows of the glasses frames and around the back of the user's head. Such devices have had limited success, but their performance has been unacceptable in many circumstances. For example, gardeners frequently have found such devices to be inadequate. In warm ambient conditions when the user assumes a downwardly facing head orientation, such devices do nothing to block perspiration from the wearer's eyes and users have frequently found that sun glasses with conventional frames still slide down the bridge of the user's nose compromising both vision and protection from harsh UV radiation.

In some cases, visors and shields have been used in connection with headbands of various types to protect the user's eyes. Examples of such devices are shown in U.S. Pat. Nos. 5,752,280; 5,105,475; and Des. 284,710. However, such devices have been limited to shields and protective devices. Their structure was generally unsuited for the form and fit required to maintain lenses in sufficiently close proximity to the eyes to serve the purposes of sun glasses.

Accordingly, there was a need in the prior art for a combination of a sweat band and sun glasses that would better retain their position on the user's face under extreme conditions of use.

### SUMMARY OF THE INVENTION

In accordance with the presently disclosed invention, headwear includes a band and lenses that are connectable by fasteners, each of said fasteners having one part that is connected to the band and a complementary part that is connected to one of the lenses. The band may be an elongated, ribbon-shaped material with opposite ends that may be secured together. At times when worn by a user, the opposite ends are connected together so as to place the material in a band of appropriate size so that the headwear is securely positioned on the user's head. In this way, the headwear retains the lenses in their proper position notwithstanding the user's physical movements or level of perspiration. Preferably, the headwear also includes a sheet of overlay material that covers the portion of the lenses that is connected to the complementary part of the fasteners. Preferably, the complementary part of the fasteners is connected to the sheet of overlay material and the sheet of overlay material is connected to the band.

The fasteners may include hook-and-loop fasteners, snap-type fasteners, and hook and eye fasteners. The band may be in the form of a closed loop or a strip that has fasteners on each end that may cooperate to connect the ends of the strip together. The band can be comprised of an absorbent material that includes a plurality of layers for absorbing perspiration.

In some embodiments, the band and the sheet of overlay material are secured together to form a pocket. The pocket is large enough to receive the lenses when they are connected together by a bridge. An opening at the top of the pocket receives the connected lenses and two openings at the bottom of the pocket allow portions of each of the lenses to extend from the pocket. A connection between the overlay material and the band is located in the midsection of the overlay material between opposite ends thereof. The connection between the overlay material and the band cooperates with a bridge that connects the lenses together to retain a portion of each of the connected lenses in the pocket at times when another portion of each of the lenses extends past the lower edge of the band and outside the pocket.

### BRIEF DESCRIPTION OF THE DRAWINGS

Several presently preferred embodiments of the presently disclosed invention are shown and described in connection with the accompanying drawings wherein:

FIG. 1 is a perspective view of the disclosed headwear wherein eye lenses are attached to a headband.

FIG. 2 is a perspective view of the headwear shown in FIG. 1 with portions of internal structure shown by hidden lines.

FIG. 3 is an elevation view of the back side of a particular embodiment of the overlay sheet that is shown in FIGS. 1 and 2.

FIG. 4 is an elevation view of the back side of another embodiment of the overlay sheet that is shown in FIGS. 1 and 2.

FIG. 5 is an elevation view of the back side of still another embodiment of the overlay sheet that is shown in FIGS. 1 and 2.

FIG. 6 is a front elevation view of alternative lenses that may be included in the presently disclosed invention.

FIG. 7 is a front elevation view of other alternative lenses that may be included in the presently disclosed invention.

FIG. 8 is an exploded perspective view of an alternative embodiment of the disclosed invention in which the lenses are joined by a bridge and are maintained in a pocket formed between the overlay sheet and the headband.

FIG. 9 is a top view of the embodiment of the headgear shown in FIG. 8.

### DESCRIPTION OF A PRESENTLY PREFERRED EMBODIMENT

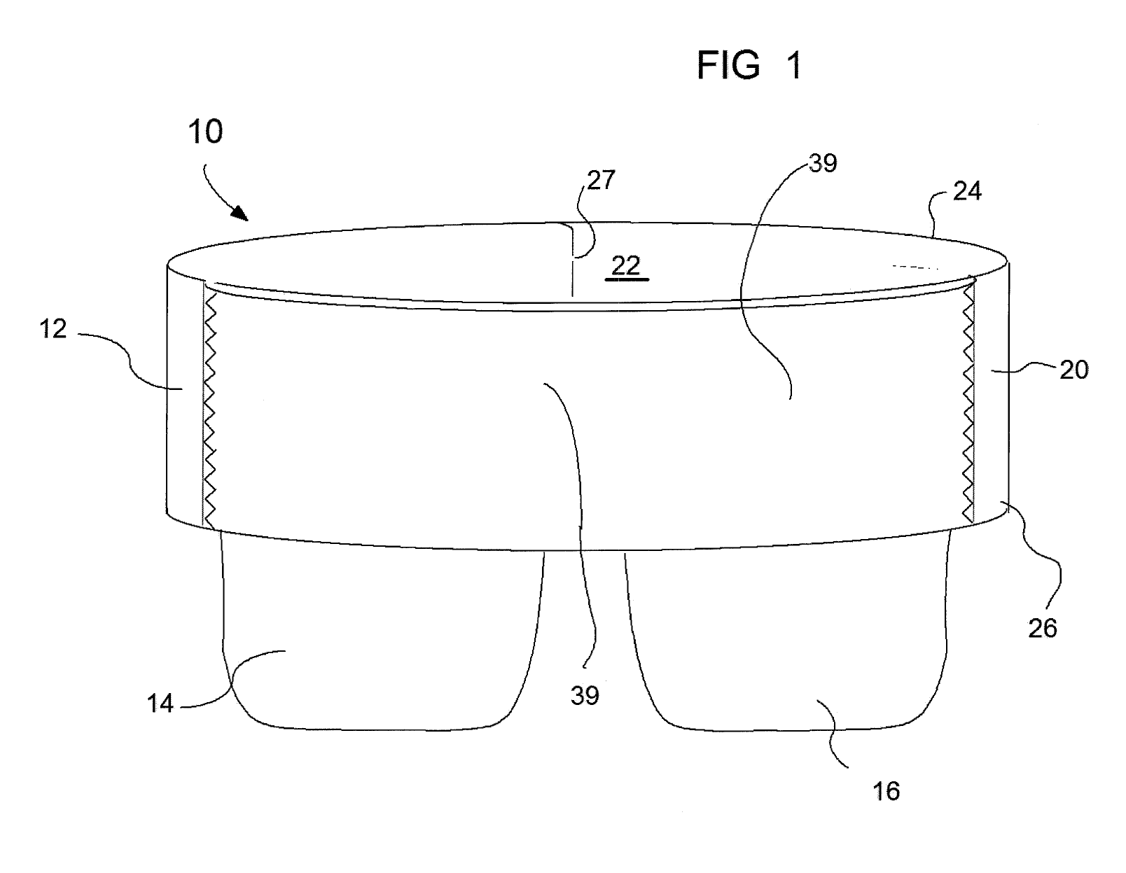

FIGS. 1-9 show several presently preferred embodiments of the invention wherein eye lenses are securely maintained in frameless sun glasses that also absorb perspiration. The presently disclosed invention secures the position of the lenses in proximity to the wearer's eyes notwithstanding conditions in which the wearer may perspire profusely or may be engaged in physical activity where jolts, turns and other head movements tend to dislodge the lenses from their intended position.

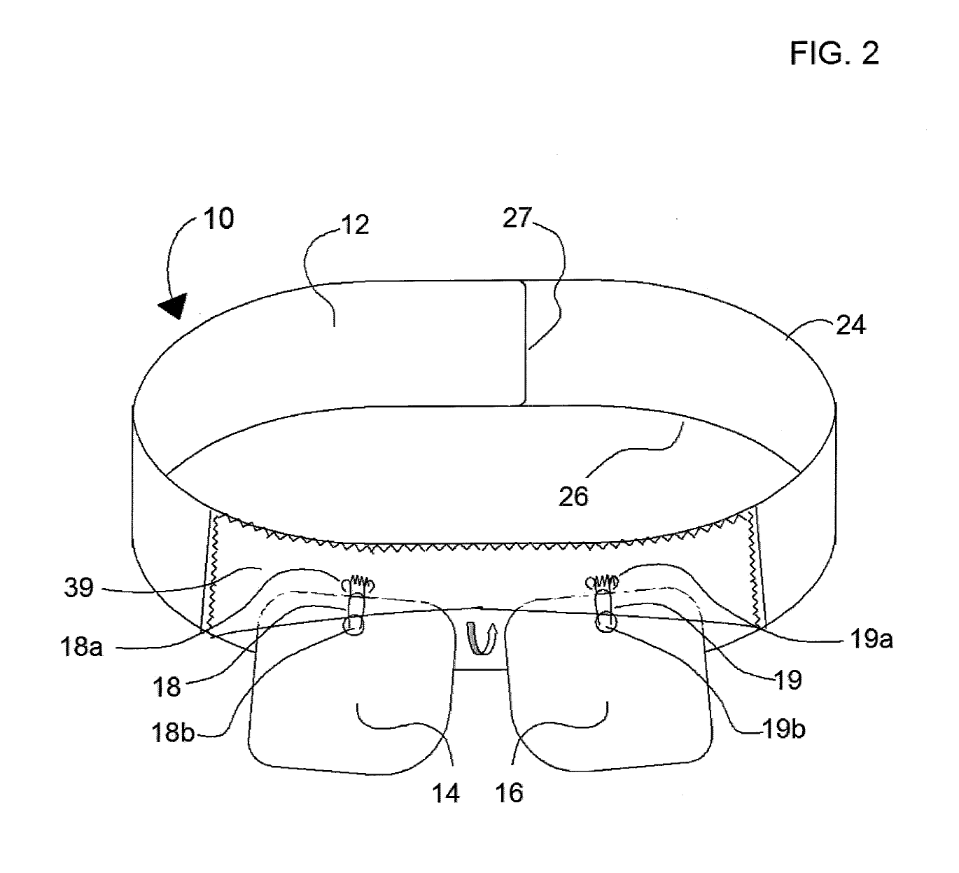

FIGS. 1 and 2 show an embodiment of the presently disclosed invention wherein headwear 10 includes a band 12 that secures lenses 14 and 16 by means of respective fasteners 18 and 19. More specifically, band 12 includes a first side 20 and a second side 22 that is oppositely disposed on band 12 from the first side. First side 20 and second side 22 are separated by edges 24 and 26 that are also oppositely located on band 12 with respect to each other. Band 12 may be in an elongate, ribbon-type form having opposite ends 27 and 28 that can be secured together such as by cooperating fasteners or by tying so as to fit the wearer's head while in sufficient tension so that it is securely positioned on the user's head. In addition, band 12 may be formed of a liquid-absorbent material so that it will absorb perspiration on the wearer's head and counteract moist conditions that tend to allow band 12 to slip out of position on the wearer's head. Band 12 may include more than one layer of liquid-absorbing material to further improve the capability of band 12 to wick moisture away from the wearer's skin.

From the description in connection with FIGS. 1 and 2 and the discussion of the presently disclosed invention in connection with other embodiments of the invention that are specifically shown and described herein, it will be apparent to those skilled in the art that band 12 may be in the form of a linear strip that is connectable at its opposite ends.

Lenses 14 and 16 are of the type such as sun glasses that have low transmittance of radiation that is within a predetermined frequency band of the visible spectrum. In some cases, lenses 14 and 16 may also have low transmittance of radiation that is within the ultraviolent spectrum.

The embodiments disclosed herein show that the disclosed headwear may include a sheet of overlay material 39. In FIGS. 1 and 2, the sheet of overlay material 39 covers the portions of the lenses that are connected to band 12. In some cases, the overlay material may be connected to one part of a fastener (such as a hook and loop fastener, or a snap-type fastener) that cooperates with a complementary part of the fastener that is connected to band 12 to removably secure sheet 39 to band 12. In other embodiments, sheet 39 can be permanently fixed to band 12 such as by stitches or adhesives.

As further shown in FIGS. 2-7, lenses 14 and 16 of headwear 10 are connected to a first side 40 of overlay 39 by respective fasteners 18 and 19. Overlay 39 is connected, in turn, to first side 20 of band 12. Fasteners 18 and 19 are of the type that includes first parts 18a and 19a and second parts 18b and 19b that cooperate in complementary fashion with the respective first parts. One part of each of fasteners 18 and 19 is secured to first side 40 of overlay 39 and the other part of fasteners 18 and 19 is secured to the respective lens 14 and 16. The embodiments of FIGS. 2-7 show that the fastener parts 18a and 19a may be indirectly connected to side 20 of band 12 by connection to a fabric sheet such as overlay 39 that is, in turn, connected to side 20 of band 12.

In the embodiments of FIGS. 1-7, lenses 14 and 16 are secured to band 12 by assembling the first parts 18a and 19a with respective, complementary second parts 18b and 19b of fasteners 18 and 19. For example, as shown in FIGS. 4 and 7, fasteners 18 and 19 each may include the male part 18a and 19a of a snap type fastener together with the female part 18b and 19b of the snap type fastener. Lenses 14 and 16 are secured to band 12 by joining male part 18a, 19a and female part 18b, 19b of the respective fasteners.

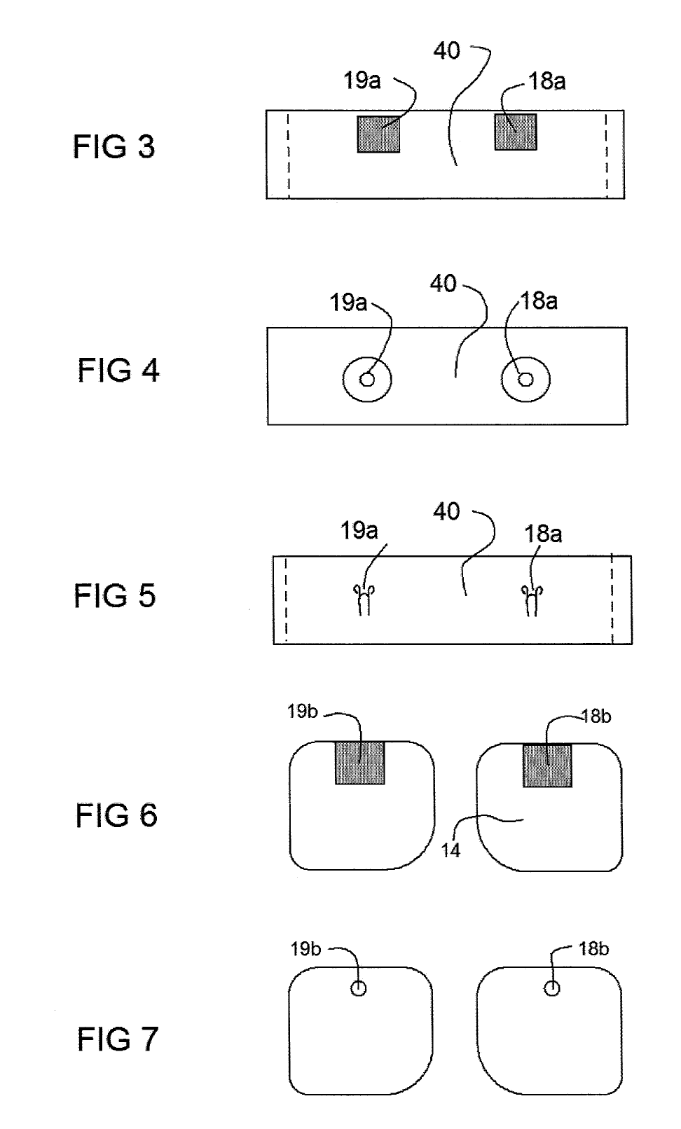

Alternative fasteners also could be used in place of the snap type fasteners 18, 19 shown in FIGS. 4 and 7. For example, hook-and-loop fasteners 18, 19 with hook portions 18a and 19a and loop portions 18b and 19b are shown in FIGS. 3 and 6. Other alternative fasteners such as hook and eye fasteners 18, 19 with hook portions 18a, 19a and eye portions 18b, 19b are shown in FIGS. 2 and 5.

Lenses 14 and 16 also could be attached by inverting the positions of first parts 18a and 19a with second parts 18b and 19b. Preferably, the fastener part that is secured to band 12 is secured to side 40 of overlay 39 with side 40 being opposed to a portion of the outer side 20 of band 12 as shown in FIGS. 1-7. Thus, the fastener part that is secured to band 12 is directly secured to side 40 of overlay 39 that forms the inside surface of overlay 39 as shown in FIG. 2.

In embodiments where overlay sheet 39 is permanently secured to band 12, sheet 39 covers the fasteners 18a and 19a to which the complementary fasteners 18b and 19b on the lenses engage. In such embodiments, access to fasteners 18a and 19a is by manually displacing sheet 39 sufficiently to expose fasteners 18a and 19a so that lenses 14 and 16 may be attached by connecting fasteners 18a and 19a to fasteners 18b and 19b respectively, as particularly shown in FIG. 2. Sheet 39 has sufficient resilience that, when released, it returns to its normal position so that it covers the top portion of lenses 14 and 16.

The part of each fastener 18b and 19b that is secured to lenses 14 and 16 and the complimentary part of the fastener 18a and 19a that is secured to overlay 39 are laterally positioned on the surface of lenses 14 and 16 and on the side 40 of overlay 39 respectively so that at times when the lenses are secured to overlay 39, the portion of each of lenses 14 and 16 through which viewing is intended extends outwardly from band 12 beyond edge 26 of band 12. In this way, at times when the user is wearing band 12 around their head, their line-of-sight through lenses 14 and 16 is properly aligned with their normal line of vision. Fine adjustments to the location of lenses 14 and 16 on the wearer's face can be had by adjusting the position of band 12 on the user's head.

FIGS. 2-7 illustrate how fastener parts 18a and 19a are indirectly connected to side 20 of band 12 by connection of fastener parts 18a and 19a to sheet 39. Sheet 39, in turn, is connected to side 20 of band 12 by fasteners, stitching, adhesive or other manner as discussed previously herein. FIGS. 2 and 5 show an embodiment wherein parts 18a and 19a are hook parts of respective hook-and-loop fasteners. Parts 18b and 19b in FIG. 2 are the complementary loop parts of the hook-and-loop fasteners. A further alternative embodiment is shown in FIGS. 4 and 7 which show a snap-type fastener having male portion 18a, 19a and female portion 18b, 19b. Male portions 18a, 19a are connected to side 40 of sheet 39 and sheet 39 is connected to side 20 of band 12. Female portions 18b, 19b of respective snap-type fasteners are connected to lenses 14 and 16. Lenses 14 and 16 are attached to sheet 39 and band 12 by connecting male portions 18a, 19a to female portions 18b, 19b. Similarly, FIGS. 3 and 6 show a hook and loop type fastener in which a hook material 18a, 19a that is attached to side 40 of sheet 39 cooperates with a loop material 18b, 19b that is attached to a lens 14 or 16. Hook material 18a, 19a is selectively engaged with loop material 18b, 19b to connect lenses 14 and 16 to sheet 39 and band 12. Other examples of fasteners having one part attached to lenses 14 and 16 and a complementary part attached to one side of band 12 are also contemplated as within the scope of this disclosure.

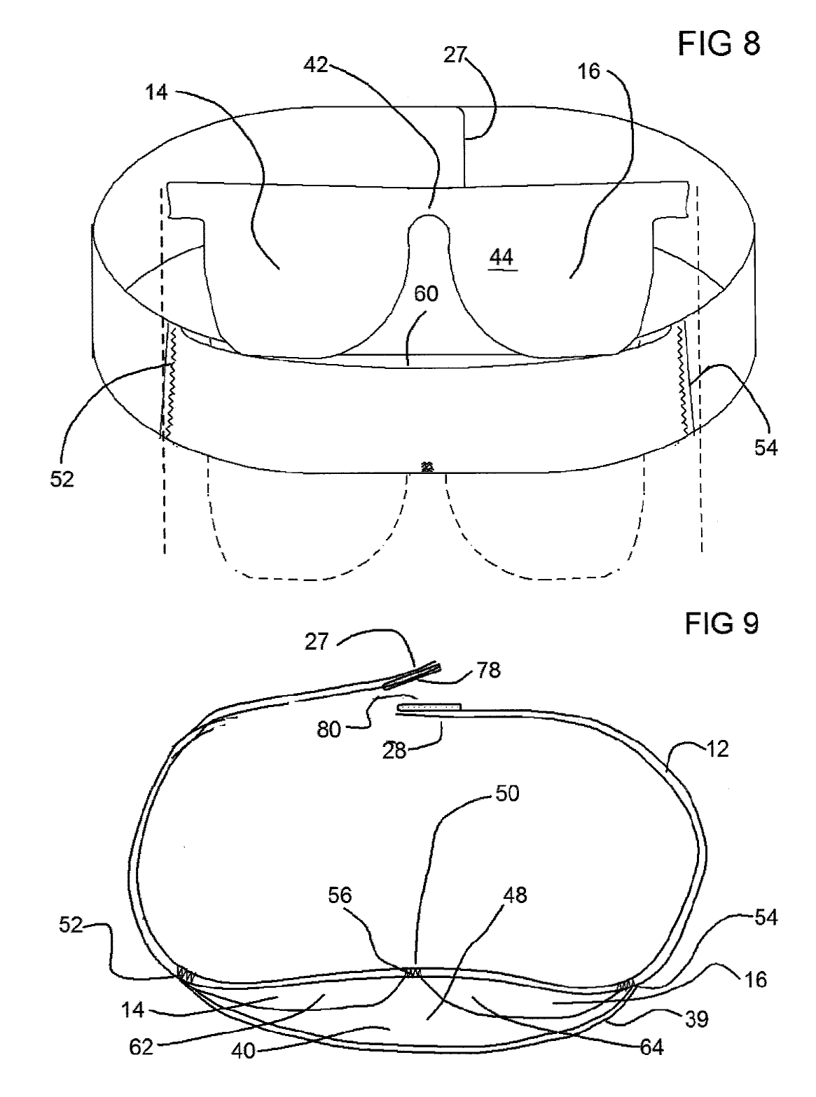

FIGS. 8 and 9 show another embodiment of the presently disclosed invention wherein lenses 14 and 16 are connected by a bridge 42 to form a subassembly 44. In this embodiment, lenses 14 and 16 may be secured to side 40 of sheet 39 according to the manner previously described in connection with embodiments of FIGS. 1-7. In addition, when lenses 14 and 16 are joined by bridge 40 as shown in FIGS. 8 and 9, the lenses can be secured in a pocket formed between side 20 of band 12 and side 40 of sheet 39. Sheet 39 is secured to band 12 at opposite ends of sheet 39. Sheet 39 may be permanently secured to side 20 of band 12 by stitches or adhesives, or may be removably secured by fasteners. In one embodiment, one part of a hook-and-loop fastener such as the hook part is secured to side 20 of band 12 and the other part of the hook-and-loop fastener such as the loop part is fixed to side 40 of sheet 39. In this embodiment, sheet 39 overlays portions of lenses 14 and 16 and bridge 40 to secure subassembly 44 to band 12 by maintaining subassembly 44 in the pocket defined between side 20 of band 12 and side 40 of overlay 39. In some embodiments, subassembly 44 may include parts of the hook-and-loop fastener that are complementary to the part of the hook-and-loop fastener of sheet 39 to further secure the subassembly 44 to sheet 39 and band 12. For example, if sheet 39 is made of a hook portion, it would connect to respective loop portions that are secured to side 20 of band 12 and to subassembly 44.

FIGS. 8 and 9 further detail how band 12 is an elongated piece of material and the lenses 14, 16 are partially maintained in a pocket 48. Band 12 defines opposite sides 20 and 22 that are separated by edges 24 and 26 as well as oppositely disposed ends 27 and 28. The embodiment of FIGS. 8 and 9 further includes sheet of overlay material 39 that is secured to side 20 of band 12. Overlay sheet 39 cooperates with band 12 to form a pocket 48 between side 40 of overlay sheet 39 and side 20 of band 12.

In the embodiment of FIGS. 8 and 9, lenses 14 and 16 are connected together by a bridge structure such as parallel rods or other appropriate connector 42. Sheet 39 includes a midsection 50 that is approximately midway between the ends 52 and 54 of sheet 39. Sheet 39 is connected to side 20 of band 12 at midsection 50 by stitches 56 or other suitable connector. Pocket 48 is open along the edge 24 of band 12. The opening 60 of pocket 48 that is defined between edge 24 and sheet 39 extends for a sufficient length along edge 24 that connected lenses 14 and 16 are insertable through the opening 60 at times when they are oriented lengthwise with respect to edge 24 as shown in FIGS. 8 and 9. Additionally, portions of pocket 48 are open between sheet 39 and edge 26 of band 12 to form openings 62 and 64 and between sheet 39 and side 20 of band 12 along edge 26. That is, pocket 48 defines openings 62 and 64 along edge 26 on opposite sides of stitches 56 and oppositely located on band 12 from opening 60. Openings 62 and 64 each extend for respective sufficient lengths along edge 26 so that each of lenses 14 and 16 can extend through respective openings 62 and 64 at times when the bridge structure 42 is in contact with stitches 56 or other connector between sheet 39 and band 12. In this way, lenses 14 and 16 may be inserted through opening 60 and also partially pass through respective openings 62 and 64 such that the portions of lenses 14 and 16 through which viewing is intended extend past the edge 26 of band 12.

Band 46 further includes fasteners 78 and 80 on ends 27 and 28 respectively. In the embodiment of FIGS. 8 and 9, fastener 78 is a hook part of a hook-and-loop fastener and fastener 80 is the loop part of a hook-and-loop fastener. A user can thus place band 12 around their head and secure fasteners 78 and 80 together so as to apply a selected degree of tension on band 12 to securely maintain band 12 on the user's head. The elevation and angular position of band 12 on the user's head is selected to locate lenses 14 and 16 over the user's eyes such that the lenses are securely maintained in the wearer's line of sight notwithstanding the user's activity.

As will be apparent to those skilled in the art, the presently disclosed invention can be also be otherwise variously embodied within the scope of the following claims.

1. Headwear comprising:
a band that defines first and second sides that are oppositely disposed between first and second edges;
a sheet of overlay material that is secured to the first side of said band, said overlay material defining a side that is opposed to the first side of said band;
at least one lens that defines first and second sides;
a first fastener that is secured to at least one side of said lens; and
a second fastener that is complementary to said first fastener and that is selectively coupled and uncoupled with said first fastener, said second fastener being connected to the side of said overlay that opposes the first side of said band.)

2. The headwear of claim 1 wherein one of said first and second fasteners is a hook portion of a hook-and-loop fastener and the other of said first and second fasteners is a loop portion of a hook-and-loop fastener.

3. The headwear of claim 1 wherein one of said first and second fasteners is a male part of a snap-type fastener and the other of said fasteners is a female part of a snap-type fastener.)

4. The headwear of claim 1 wherein one of said first and second fasteners defines the eye portion of a hook-and-eye fastener and the other of said fasteners defines the hook portion of a hook-and-eye fastener that is receivable in said eye portion.)

5. The headwear of claim 1 wherein said band defines first and second oppositely disposed ends, said band further including a third fastener on one of said first and second oppositely disposed ends of said band and a fourth fastener that is complementary to said third fastener and that is secured to the other of said first and second oppositely disposed ends of said band, said third and fourth fasteners cooperating to selectively couple the oppositely disposed ends of the band together.)

6. The headwear of claim 5 wherein said third fastener is the hook portion of a hook-and-loop fastener and the fourth fastener is the loop portion of a hook-and-loop fastener.)

7. The headwear of claim 1 wherein one of said first and second fasteners is a hook portion of a hook-and-loop fastener and the other of said first and second fasteners is a loop portion of a hook-and-loop fastener.)

8. The headwear of claim 1 wherein one of said fasteners is a male part of a snap-type fastener and the other of said fasteners is a female part of a snap-type fastener.)

9. The headwear of claim 1 wherein one of said fasteners is an eye portion of a hook-and-eye fastener and the other of said fasteners is a hook portion of a hook-and-eye fastener that is receivable in said eye portion.)

10. The headwear of claim 1 wherein said second fastener is connected to the first side of said band by attachment to said sheet of overlay material that is secured to the first side of said band.)

11. The headwear of claim 1 wherein said at least one lens has low transmittance of radiation that is within a predetermined frequency band of the visible spectrum.)

12. The headwear of claim 1 wherein said at least one lens has low transmittance of radiation that is within the ultraviolent spectrum.)

13. The headwear of claim 1 wherein said band is comprised of liquid-absorbent material.)

14. The headwear of claim 13 wherein said band is comprised of two or more layers of material.)

15. The headwear of claim 14 wherein at least one of said layers is a liquid-absorbent material.)

16. Headwear comprising:
a band that defines first and second sides that are oppositely disposed between first and second edges;
a sheet of overlay material that is secured to the first side of said band, said overlay material defining a side that is opposed to the first side of said band, said sheet of overlay material cooperating with said band to define at least one pocket between the first side of said band and said sheet of overlay material; and
at least one lens that defines first and second sides, a portion of said at least one lens being retained in said pocket and another portion of said at least one lens extending out of said pocket and beyond one edge of the band.)

17. The headwear of claim 16 wherein said sheet of overlay material includes first and second ends and a midsection that is located between the first and second ends of the sheet of overlay material, said midsection of said sheet of overlay material being connected to said band, and wherein said at least one lens comprises two lenses that are secured together by a bridge structure, said bridge structure cooperating with the sheet of overlay material, the first side of the band, and the connection between the midsection of the sheet of overlay material and said band to retain said bridge structure in said pocket at times when portions of each of said two lenses extend outside of said pocket.
